(19) United States
(12) Patent Application Publication
(10) Pub. No.: US 2015/0160801 A1
(43) Pub. Date: Jun. 11, 2015

(54) USER INTERFACES FOR GRID NAVIGATION

(71) Applicant: SURFWAX, INC., Menlo Park, CA (US)

(72) Inventor: Thomas D. Holt, Atherton, CA (US)

(21) Appl. No.: 14/625,371

(22) Filed: Feb. 18, 2015

Related U.S. Application Data
(63) Continuation of application No. 13/739,880, filed on Jan. 11, 2013, now abandoned.
(60) Provisional application No. 61/696,758, filed on Sep. 4, 2012.

(51) Int. Cl. G06F 3/0482; G06F 3/0485

(52) U.S. Cl. CPC G06F 3/0482; G06F 3/0485

(57) ABSTRACT

User interfaces for grid navigation. In one example embodiment, a non-transitory computer-readable medium stores a program configured to cause a processor to generate a user interface. The user interface includes a grid including horizontal rows and vertical columns, a plurality of multidimensional grid cells each having a specific position in the grid, and a viewport configured to display only a portion of the grid and configured to scroll the grid in any direction within the viewport upon receiving a first diagonal scrolling input that indicates a diagonal scrolling direction. The viewport is further configured to scroll the grid exactly along either a column or a row within the viewport upon receiving the first diagonal scrolling input in combination with a simultaneous second input from the user.

### CROSS-REFERENCE TO A RELATED APPLICATION

This application is a continuation of U.S. patent application Ser. No. 13/739,880, filed on Jan. 11, 2013, which claims priority to and the benefit of U.S. Provisional Patent Application Ser. No. 61/696,758, filed on Sep. 4, 2012, each of which is incorporated herein by reference in its entirety.

### BACKGROUND

Grid-based user interfaces often store content in rows and columns of cells. In general, a user is able to navigate the grid of the user interface in order to arrive at particular cells in the grid. Unfortunately, current grid-based user interfaces are not capable of complex navigation that allows a user to navigate the grid in complex ways.

### BRIEF SUMMARY OF SOME EXAMPLE EMBODIMENTS

In general, example embodiments of the invention relate to user interfaces for interrupted grid navigation, multi-input scrolling, and displaying spanner cells. Also, at least some of the example user interfaces disclosed herein enable multiple predetermined inputs to be designated to enable a user to scroll through a grid right or left along a row or up or down along a column. The multi-input scrolling may enable the user to scroll exactly along a row or column even though the user is not able to achieve an exactly horizontal or vertical scrolling input, such as a finger swipe on a touch display or a clicked mouse drag of a mouse pointer. Further, at least some of the example user interfaces disclosed herein enable spanner cells having content that spans multiple columns or rows to be displayed in a single column or row. Each spanner cell may enable a user to view the spanner cell at the beginning of the span or at the end of the span.

In one example embodiment, a non-transitory computer-readable medium stores a program configured to cause a processor to generate a user interface. The user interface includes a grid including horizontal rows and vertical columns, a plurality of multidimensional grid cells each having a specific position in the grid, and a viewport configured to display only a portion of the grid and configured to scroll the grid in any direction within the viewport upon receiving a first diagonal scrolling input that indicates a diagonal scrolling direction. The viewport is further configured to scroll the grid exactly along either a column or a row within the viewport upon receiving the first diagonal scrolling input in combination with a simultaneous second input from the user.

In another example embodiment, a non-transitory computer-readable medium stores a program configured to cause a processor to generate a user interface. The user interface includes a grid including rows and columns, a header row of header row cells each positioned in a separate column of the grid, and a plurality of cells each having a specific position in the grid. The cells include one or more spanner cells. Each spanner cell includes content that corresponds to multiple header row cells but the spanner cell is displayed in only a single one of the columns in which the corresponding header row cells are positioned.

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

Additional features will be set forth in the description which follows or may be learned by the practice of the teachings herein. Features of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

To further clarify certain aspects of the present invention, a more particular description of the invention will be rendered by reference to example embodiments thereof which are disclosed in the appended drawings. It is to be understood that the drawings are diagrammatic and schematic representations of such example embodiments, and are not limiting of the present invention, nor are they necessarily drawn to scale. Aspects of the invention will be described and explained with additional specificity and detail through the use of the accompanying drawings in which:

FIG. 1 illustrates an example tablet computer environment in which an example user interface having a grid of cells is displayed with a user navigating the grid;

FIG. 2 illustrates the example user interface of FIG. 1 with the user interface displaying priority regions of one or more cells;

FIG. 3 illustrates the example user interface of FIG. 1 with a user navigating the grid using multi-input scrolling;

FIG. 4 illustrates the example user interface of FIG. 3 after the user has navigated the grid using multi-input scrolling;

FIG. 5 discloses the example user interface of FIG. 1 with multiple spanner cells each having content that spans multiple columns and appearing in the first column of the span;

FIG. 6 discloses the example user interface of FIG. 5 with the spanner cells of one row appearing in the last column of the span;

FIG. 7 discloses the example user interface of FIG. 5 with all of the multiple spanner cells appearing in the last column of the span;

FIG. 8 illustrates the example user interface of FIG. 5 with a viewport displaying a summative grid that corresponds to the grid of FIG. 5 with each summative cell corresponding to a spanner cell appearing in the first column of the span; and

FIG. 8 illustrates the example user interface of FIG. 5 with a viewport displaying a summative grid that corresponds to the grid of FIG. 5 with each summative cell corresponding to a spanner cell appearing in the first column of the span;

FIG. 9 illustrates the example user interface of FIG. 8 with each summative cell corresponding to a spanner cell appearing in the last column of the span; and

FIG. 10 illustrates an example non-transitory computer-readable medium that may store a program configured to cause a processor to generate any of the example user interfaces of FIGS. 1-9.

### DETAILED DESCRIPTION OF SOME EXAMPLE EMBODIMENTS

Example embodiments of the present invention relate to user interfaces for interrupted grid navigation, multi-input scrolling, and displaying spanner cells. At least some of the example user interfaces disclosed herein enable priority regions, including one or more cells in a grid, to be designated in order to enable interrupted grid navigation to occur when a user encounters the priority region during grid navigation. The interrupted grid navigation may cause the user to focus on the cells in the priority region. Also, at least some of the example user interfaces disclosed herein enable multiple predetermined inputs to be designated to enable a user to scroll through a grid right or left along a row or up or down along a column. The multi-input scrolling may enable the user to scroll exactly along a row or column even though the user is not able to achieve an exactly horizontal or vertical scrolling input, such as a finger swipe on a touch display or a clicked mouse drag of a mouse pointer. Further, at least some of the example user interfaces disclosed herein enable spanner cells having content that spans multiple columns or rows to be displayed in a single column or row. Each spanner cell may enable a user to view the spanner cell at the beginning of the span or at the end of the span.

As used herein, the term “grid” is not limited to a grid made up of rectangular cells organized into X-Y rows and columns. Therefore, although the grids of the example user interfaces disclosed herein are generally grids made up of rectangular cells organized into X-Y rows and columns, it is understood that the term “grid” can also encompass a grid with non-rectangular cells, such as a spherical grid, and/or a grid that does not have linear vertical and horizontal X-Y rows and columns, such as diagonal or curved rows and columns.

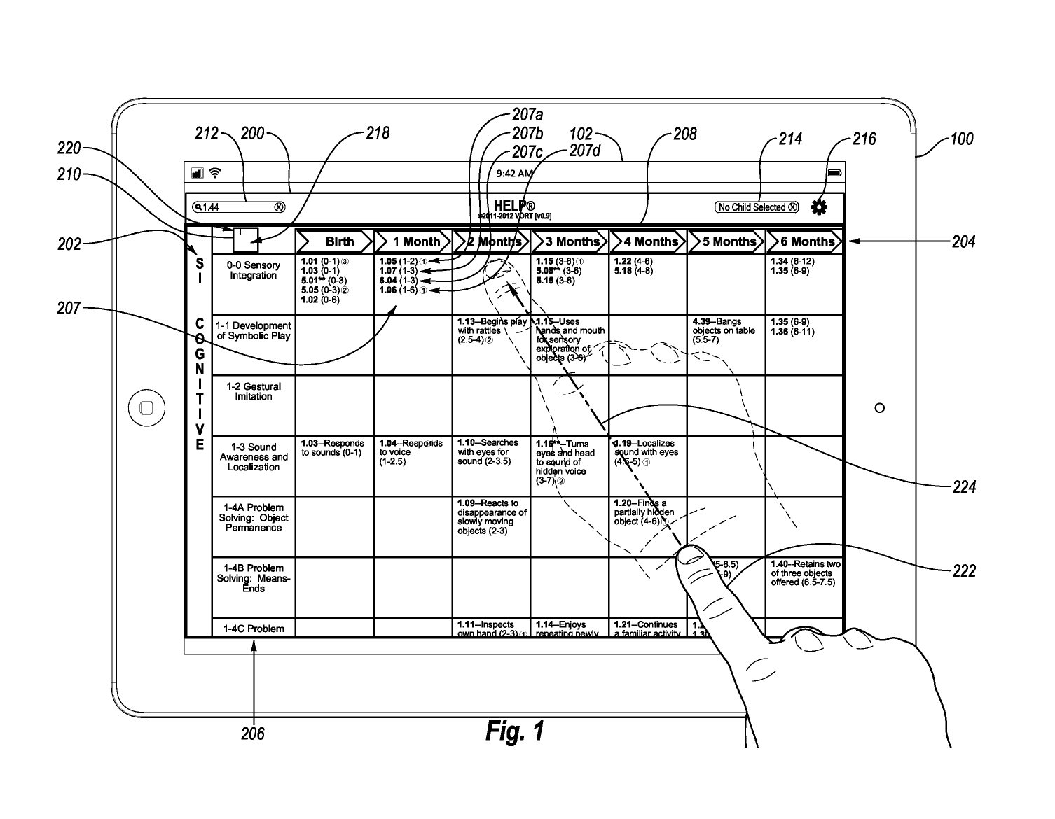

FIG. 1 illustrates an example tablet computer environment in which an example user interface having a grid of cells is displayed with a user navigating the grid. In particular, FIG. 1 discloses a tablet computer 100 having a touch display area 102. The touch display area 102 is employed in FIG. 1 to display an example user interface 200. The user interface 200 includes a grid 202. The grid 202 has rows and columns of cells, with each cell having a specific position in the grid. Each cell is configured to contain content, such as the structured content disclosed in U.S. patent application Ser. No. 13/271,882, which was filed on Oct. 12, 2011, and which is incorporated herein by reference in its entirety. Some of the cells in the grid 202 may be cluster cells. A cluster cell is a cell which itself may contain two or more separate additional cells. One example of a cluster cell is the cell 207, which contains separate additional cells 207a, 207b, 207c, and 207d. The grid 202 includes a header row 204 of header row cells and a header column 206 of header column cells.

The user interface 200 also includes a viewport 208, a viewtracker 210, a search box 212, a target box 214, and a user options selector 216.

Since the grid 202 is too large to be displayed all at once, the viewport 208 displays only a portion of the grid 202. The user interface 200 enables a user to reposition the grid 202 within the viewport 208 to allow the user to navigate to any portion of the grid 202. This repositioning may be accomplished, for example, by dragging the grid using a mouse pointer on a non-touch display or using a finger on a touch display.

The viewtracker 210 includes a grid representation 218 of the grid 202 and a viewport representation 220 of the viewport 208. The viewport representation 220 is positioned within the grid representation 218 and overlays the grid representation 218. The viewport representation 220 visually conveys both the proportion of the grid 202 currently displayed in the viewport 208 as well as the position within the grid 202 of the portion of the grid 202 displayed in the viewport 208, thereby helping the user visualize where the user is in terms of either additional or total content to be viewed or progress along the progression of the grid 202. During scrolling within the viewport 208, the viewport representation 220 may also convey the rate of travel through the grid 202.

The search box 212 allows a user to search for a specific cell or a specific cell content within the grid 202. The target box 214 displays the target of the grid. The target of the grid 202 may be, for example, an individual, a group of individuals, an animal, a computer program, a project, a company, a car model, a series of paintings, or anything to which a range or value or rating or score can be determined or assigned, for which a sense of status change or progress can be represented or tracked. In FIG. 1, the target box 214 displays the name of a target individual associated with the cell contents or cell statuses of the cells currently displayed in the grid 202. The target individual may be different from the user of the user interface 200. For example, the target individual may be a child and the user of the user interface 200 may be the child's parent, teacher, or physician. The user may access the user interface 200 to track the developmental progress of the child in each of the developmental areas covered by the content contained in each cell. Alternatively, for example, the user may be a car salesman, with the target being a specific make of car selectable under the user options selector 216 of different makes of car, with the status representing consumer ratings on the features of different models of that make of car. The user options selector 216 may be selected by the user in order to access various option menus related to the user interface 200.

Additional details about cluster cells, header rows, header columns, viewports, viewtrackers, and search boxes are disclosed in U.S. patent application Ser. No. 13/271,882.

### I. Priority Regions and Interrupted Grid Navigation

A user can navigate to cells within the grid 202 using a variety of methods including searching using the search box 212, viewtracker navigation using the viewtracker 210, and scrolling vertically, horizontally, or both vertically and horizontally simultaneously (diagonally). The grid 202 may be configured such that during a user's navigation of the grid (“grid navigation”), the user is interrupted from normal navigation in order to focus the user's attention on a specific region of the grid. This interruption from normal grid navigation may be accomplished using priority regions. As used herein, the phrase “priority region” refers to one or more cells that have been designated for interrupted grid navigation.

For example, a content author, an administrator, and/or a user may have designated one or more key cells as a priority region. These key cell(s) may include content that the content author, the administrator, and/or the user wants the user to notice or use or respond to —cells that might represent an important step or topic or a transition or key review or consideration point or content not yet mastered—content that should not be overlooked, but might inadvertently be overlooked, because the scrolling momentum or other navigation takes the movement of the cells within the viewport 208 beyond the priority cells in the viewport 208. Since the scrolling momentum or other navigation might carry grid 202 within the viewport 208 past these priority cells, and to make sure priority key cell(s) are noticed/used, the content author, the administrator, and/or the user can set a pre-defined priority region, which will cause the scrolling momentum or other navigation to slow or come to a complete stop, or some other form of navigation interruption mentioned above, so that the user will hopefully read or notice the content of the priority cell(s) in the priority region.

It is understood that the “scrolling momentum” discussed herein generally refers to the standard scrolling of a display provided, for example, by an operating system and in which the scrolling speed is either directly and continuously controlled and stopped by a user (using a standard scroll bar or a dragging scroll, for example) or is initiated by a user but is then controlled and stopped by the display (using a swipe scroll where a user swipes quickly on a touch display and upon breaking contact with the display the scrolling continues for a preset period of time, sometimes based on the speed of the swipe, and then gradually slows to a stop, for example).

For example, while navigating the grid 202, a user may scroll through grid cells presented in the viewport 208 by swiping a finger 222 along the navigation vector 224 on the touch display are 102. As noted previously, the viewport 208 may display only a portion of the cells that constitute the entire grid 202. In the example embodiment disclosed in FIG. 1, the grid 202 has 37 columns by 62 rows, but the viewport only displays a portion of those cells at a given time, such as the cells in a 7-column-by-6-row portion of the grid 202. In this example, the single diagonal scrolling swipe of a user's finger 222 along the navigation vector 224, as illustrated in FIG. 1, may allow the entire height (and a portion of the width) of the grid 202 to be navigated via diagonal scrolling of the grid 202 within the viewport 208. However, the momentum of the scrolling of the grid 202 within the viewport 208 may be interrupted where a priority region appears in the viewport 208.

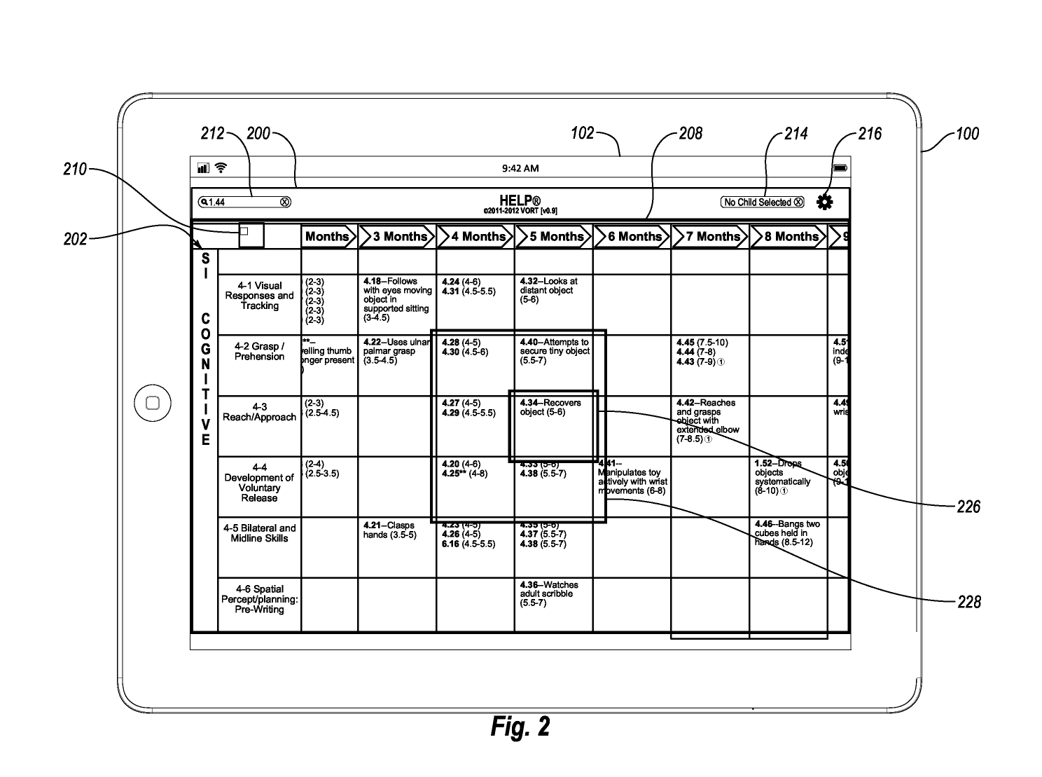

FIG. 2 illustrates the example user interface 200 of FIG. 1 with the user interface 200 displaying priority regions 226 and 228 of one or more cells. In particular, priority region 226 includes a single cell and priority region 228 includes six cells. It is understood that although both priority regions 226 and 228 are disclosed in FIG. 2, in general, either the priority region 226 or the priority region 228 would be included in the user interface 200, although it is possible to have multiple priority regions and two or more of the priority regions may overlap in some circumstances. After the scrolling swipe disclosed in FIG. 1, the momentum of the scrolling of the grid 202 within the viewport 208 may be interrupted when either of the priority region 226 or the priority region 228 appears in the viewport 208.

This interruption in navigation may take various forms including, but not limited to, slowing momentum, stopping momentum, bouncing back to the priority region, highlighting the priority region, or some combination thereof. For example, when a user is scrolling through the grid 202 using the viewport 208, and one of the priority region 226 or the priority region 228 becomes visible in the viewport 208, the momentum of the scrolling may be interrupted by slowing or stopping. This interruption may also or alternatively occur just prior to the priority region 226 or 228 passing out of visibility in the viewport 208, or as the priority region passes through the center of the viewport 208, or as the priority region 226 or 228 passes through any other designated area of the viewport 208. In this example, the priority region 226 or 228 can force a user to take a longer look at the priority region 226 or 228, and the priority cell or cells that make up the priority region 226 or 228, than the user would if the priority region 226 or 228 were not present.

In at least some example embodiments, the grid 202 may be configured such that priority regions may be modified or eliminated by a content author, an administrator, and/or a user, such that at any point if the priority region becomes outdated or otherwise undesired, the priority region can be modified or eliminated. For example, a priority region may have an automatic or user-initiated menu, which may appear in a highlighting of a priority region, for example, that allows the priority to be modified or eliminated. Modifications may include changes in the amount of slowing caused by a priority region, or a change in the number of cells that make up the priority regions. Modification or elimination of a priority region may also appear in a preferences interface, or may be accomplished using some other device shortcut such as a certain keystroke or keystrokes or a certain finger swipe or tapping action on a touch display.

The highlighting of a priority region may include the cell(s) of a priority region changing appearance as the priority region passes through a designated portion of the viewport 208. This change in appearance may allow a user to easily distinguish cells in a priority region from other surrounding cells. The change in appearance may include cell shading, cell levitation (where the cell pops out of the grid in a 3-D setting), cell flashing, or any other form of highlighting. As noted previously, this highlighting may also include a menu or option presentation that allows for the modification or elimination of the priority region. Additionally or alternatively, all cells not in a priority region and/or other display objects may change in appearance to allow a user to easily distinguish these other cells and/or display objects from the cells in a priority region. This change in appearance may include diminishing the appearance of these other cells and/or display objects by graying them out, for example.

Once a priority region passes through the viewport 208, the navigation may continue uninterrupted until another priority region is encountered in the viewport 208. The grid 202 may also be configured such that once a user encounters a priority region, the user can be presented with the option to jump to the next priority region along the current navigation vector, such as the navigation vector 224 of FIG. 1. For example, if a user is navigating along a horizontal navigation vector in a particular row in a grid from left to right, upon encountering a first priority region in the row, the user may be enabled to jump from the first priority region to a second priority region further to the right along the same row. It is understood that the horizontal navigation vector in the above example is but one example navigation vector, and a user can instead navigate along any navigation vector such as a navigation vector going up, down, left, right, or diagonally. In this manner, a user may be able to jump from priority region to priority region without having to traverse intervening cells.

It is understood that priority regions may be employed using other forms of grid navigation methods besides scrolling including, but not limited to, searching and viewtracker navigation.

### II. Multi-Input Scrolling

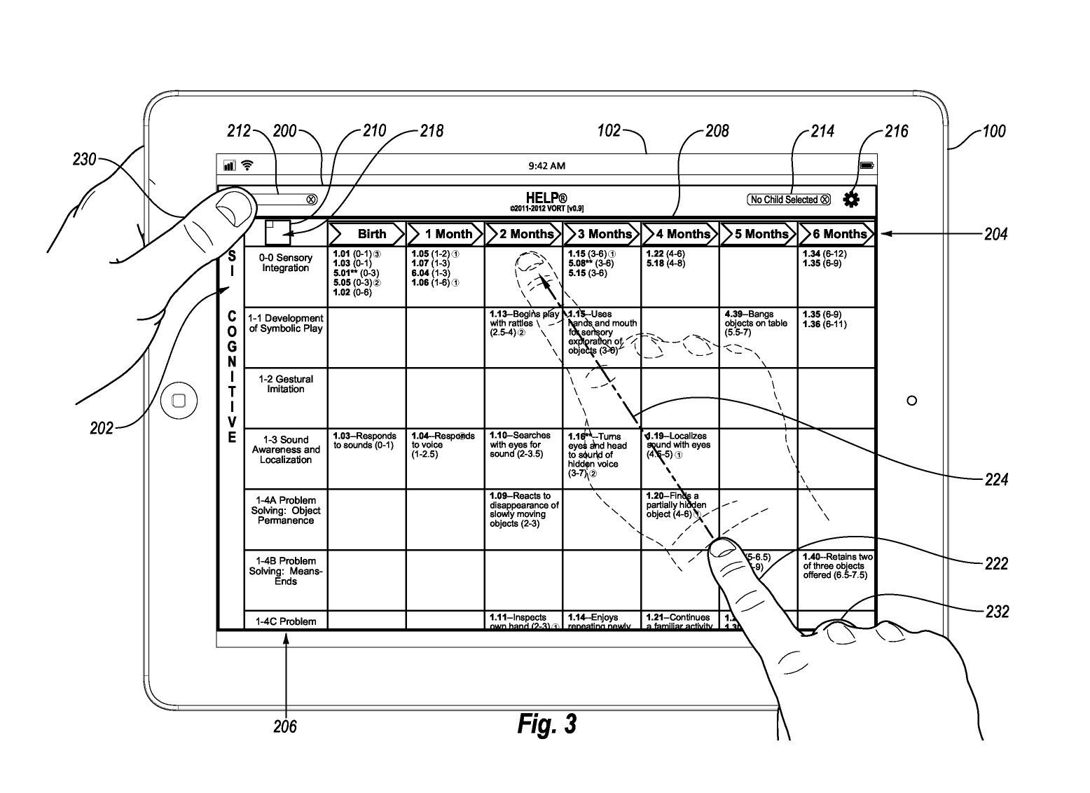

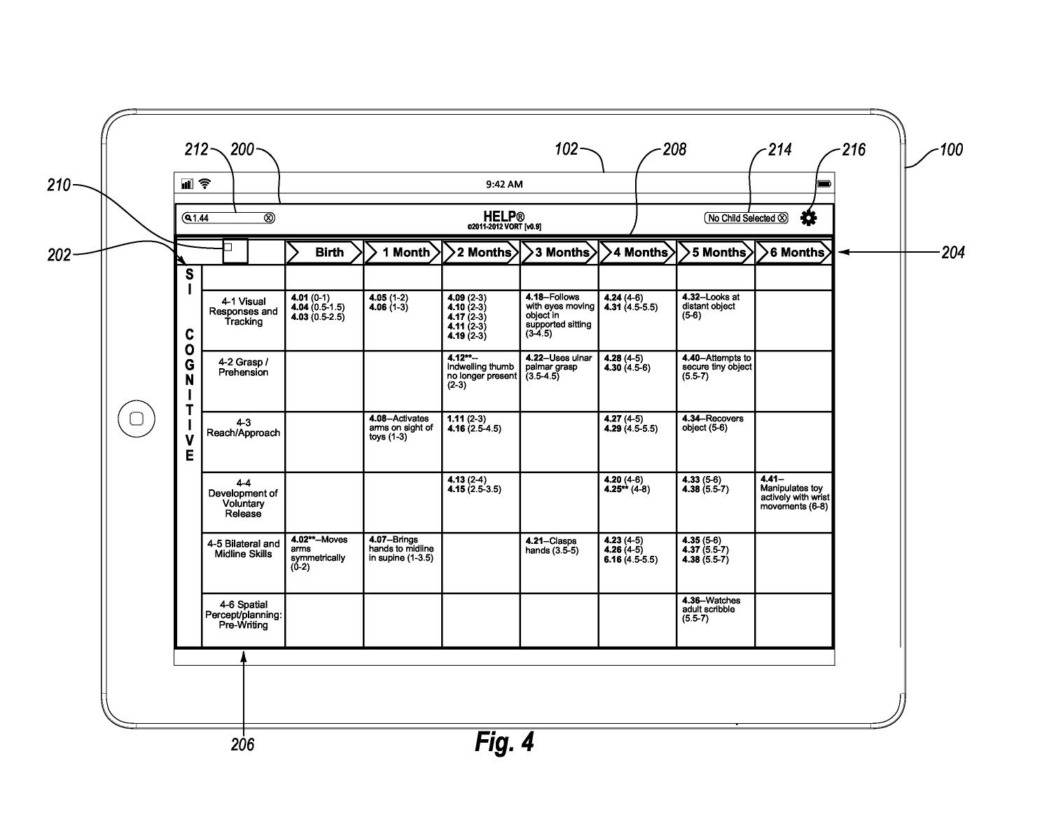

FIG. 3 illustrates the example user interface 200 of FIG. 1 with a user navigating the grid 202 using multi-input scrolling and FIG. 4 illustrates the example user interface 200 of FIG. 3 after the user has navigated the grid 202 using multi-input scrolling. Since the example grid 202 disclosed herein allows a user to scroll in any direction, including any diagonal direction, in at least some example embodiments it may be useful to assist a user in scrolling exactly along either a vertical or a horizontal axis (i.e., along a vertical column or a horizontal row) in the grid 202. The user may activate this assistance by providing multiple predetermined scrolling inputs to the viewport 208. For example, the viewport 208 is configured to scroll the grid 202 exactly along either a vertical or a horizontal axis within the viewport 208 upon receiving a first standard scrolling input from a user in combination with a simultaneous or non-simultaneous second input from the user.

For example, in the touch-screen environment of FIG. 3, a first standard scrolling input may include a first swipe with a first finger 222 along a navigation vector 224, while a second input may include a simultaneous second touch with a second finger 230. The viewport 208 may be configured to recognize the simultaneous second touch with the second finger 230 as a second input that causes the viewport to ignore any diagonal movement in the swipe and instead scroll the grid only along a vertical axis, since the vertical component of the indicated scrolling direction represented by the navigation vector 224 is more pronounced than a horizontal component of the indicated scrolling direction represented by the navigation vector 224. As used herein, the term “more pronounced” generally refers to the angle of one component of a navigation vector being greater than the angle of another component of the navigation vector. For example, on a rectangular display, a vertical component of a navigation vector is “more pronounced” than a horizontal component of a navigation vector if the angle between the vertical component and a horizontal baseline is greater than 45 degrees and the angle between the horizontal component and the horizontal baseline is less than 45 degrees. If, however, both angles with respect to the horizontal baseline are equal, such as where both angles are exactly 45 degrees, then neither component is “more pronounced.”

As disclosed in FIGS. 3 and 4, even though the navigation vector 224 of the swipe by the first finger 222 is slightly diagonal, the grid 202 is scrolled in an exactly vertical fashion between FIGS. 3 and 4 such that the same columns displayed in FIG. 3 prior to the swipe are also displayed in FIG. 4 after the swipe. Contrast this scrolling in an exactly vertical fashion with the diagonal scrolling disclosed in the comparison of FIGS. 1 and 2, where an identical swipe with a first finger 222 along an identical navigation vector 224 results in diagonal scrolling such that different columns are displayed in FIG. 2 after the swipe than are initially displayed in FIG. 1 prior to the swipe.

It is understood that the first scrolling input and the second input in this example could be replaced with other inputs. For example, the second input could be replaced with a second scrolling swipe using another finger 232 that is swiped in the same general direction as the first finger 222.

In an example environment that includes a mouse (not shown), for example, a first standard scrolling input may include dragging the grid 202 by moving a mouse and pressing a first mouse key, while a second scrolling input may include simultaneously pressing a second mouse key. The viewport 208 may be configured to recognize the simultaneous pressing of the second mouse key as a second input that causes the grid to ignore any diagonal movement in the mouse movement and instead scroll the grid only along either a vertical axis or a horizontal axis, depending on whether the vertical component or the horizontal component of the mouse movement is more pronounced. Where the example mouse environment also includes a keyboard, the second input may alternatively or additionally include simultaneous pressing a “Ctrl” key, or some other key, on the keyboard.

It is understood that the second scrolling input may include one or more additional inputs. Thus, a second scrolling input is not limited to a single additional scrolling input but could also include two or more additional scrolling inputs. Also, scrolling inputs are not limited to touch display, mouse, or keyboard scrolling inputs, but can also include any other type of scrolling input including voice and brain wave scrolling inputs. It is further understood that multi-input scrolling may also be employed in connection with viewtracker navigation to force the viewtracker 210 navigation to proceed only along either a vertical or a horizontal axis. It is also understood that where the vertical component or the horizontal component of a scrolling input are equally pronounced in multi-input scrolling, the user may be prompted to reenter the scrolling input. For example, this prompting may take the form of a non-scrolling of the grid 202 within the viewport 208 or a pop-up error message.

Therefore, multi-input scrolling allows a user to scroll a grid within a viewport exactly along either a vertical or a horizontal axis even though the movement of the standard scrolling input from the user may not necessarily be in a perfect line along the vertical or the horizontal axis. At the same time, a user retains the ability to scroll the grid within the viewport in any diagonal direction using standard scrolling inputs, such as a single swipe or a mouse drag.

### III. Displaying Spanner Cells

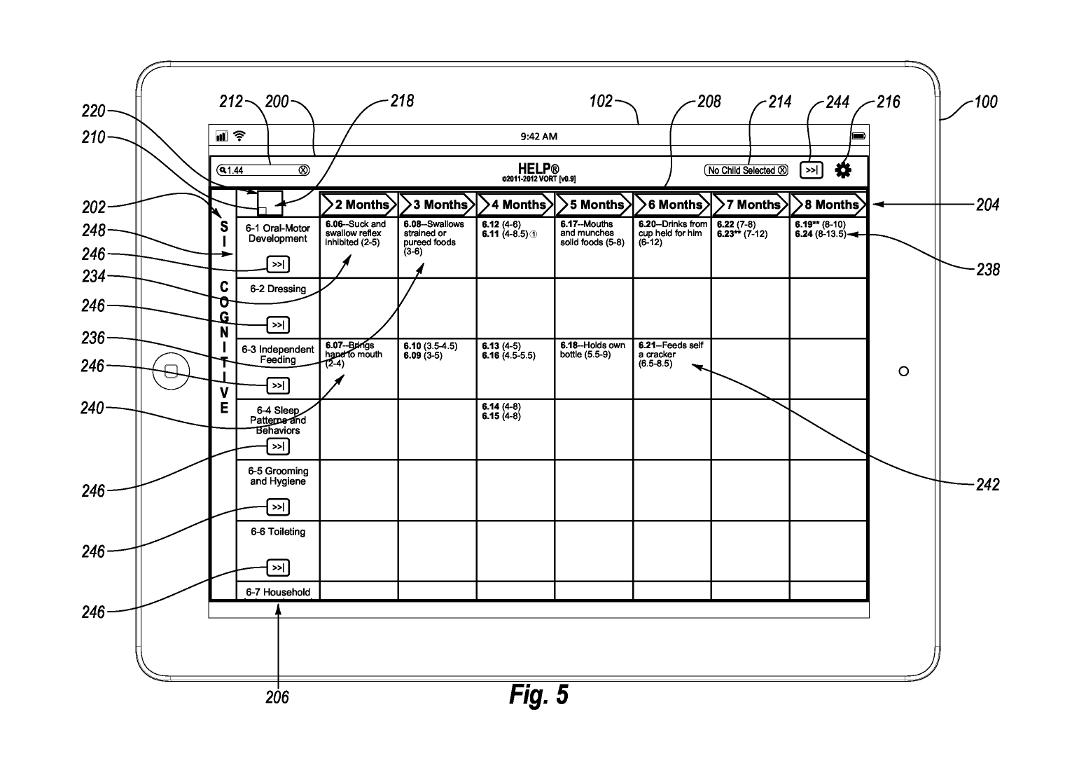

FIG. 5 discloses the example user interface 200 of FIG. 1 with multiple spanner cells each having content that spans multiple columns and appearing in the first column of the span. A “spanner cell” is a cell having content that corresponds to a range of multiple header row cells and/or multiple header column cells such that the content of the spanner cell spans a range of multiple columns and/or multiple rows. In the example embodiment of FIG. 5, each of the cells disclosed in FIG. 5 is a spanner cell having content that corresponds to a range of multiple header row cells of the header row 204 such that the content of spanner cell spans a range of multiple columns.

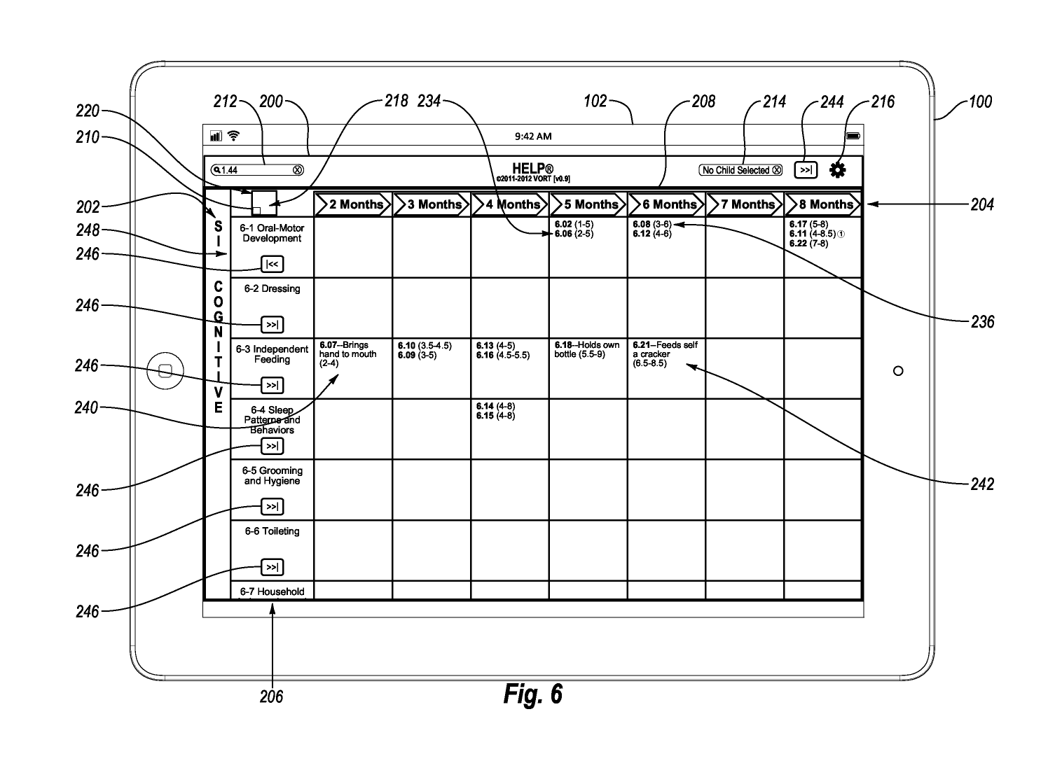

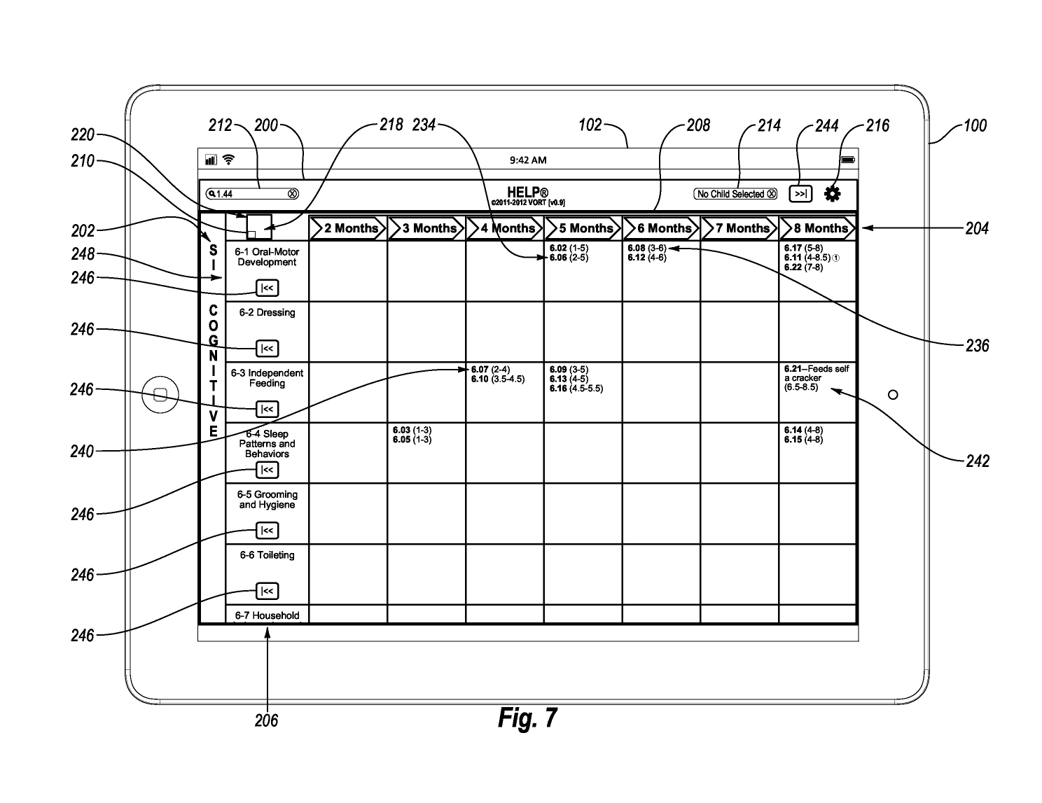

Even though each spanner cell has content that spans a range of multiple columns, each spanner cell appears in only one of the corresponding columns. For example, each spanner cell may appear in either the first corresponding column or row of the range spanned by the content of the spanner cell or the last corresponding column or row of the range spanned by the content of the spanner cell. In the example embodiment disclosed in FIG. 5, each spanner cell appears in the first corresponding column or the range spanned by the content of the cell. As will be discussed in connection with FIGS. 6 and 7, the user interface 200 may include the ability to toggle one or more spanner cells such that each toggled spanner cell instead appears in the last corresponding column of the range spanned by the content of the spanner cell.

Each spanner cell may include a spanning indicator that indicates the range of the columns or rows that are spanned by the content of the spanner cell. For example, the spanner cells in FIG. 5 each include a spanning indicator that indicates the range of ages in which a target child should master the skill contained in the spanner cell. In one example, the spanner cell 234 includes a spanning indicator “(2-5)” which indicates that the target child should master the skill of “6.06—Suck and swallow reflex inhibited” somewhere in the range between 2 months of age and 5 months of age. The spanner cell 234 appears in the first column of this range in FIG. 5. In another example, the spanner cell 242 includes a spanning indicator “(6.5-8.5)” which indicates that the target child should master the skill of “6.21—Feeds self a cracker” somewhere in the range between 6.5 months of age and 8.5 months of age. The spanner cell 242 appears in the first column of this range in FIG. 5. It is understood that the spanning indicators disclosed in FIG. 5 are just one example format for a spanning indicator, and any other spanning indicator that indicates the columns or rows that are spanned by the content of a spanner cell could instead be employed.

The user interface 200 may also be configured to receive one or more toggling inputs that toggle each of at least some portion of the spanner cells in the grid 202 between appearing in the first corresponding column or row spanned by the content of the spanner cell and appearing in the last corresponding column or row spanned by the content of the spanner cell. For example, a grid toggle button 244 may be included in the user interface of FIG. 5. The grid toggle button 244 may enable a user to enter a toggling input into the user interface 200 that toggles each of the spanner cells in the grid 202 between appearing in the first corresponding column spanned by the content of the spanner cell and appearing in the last corresponding column spanned by the content of the spanner cell. The grid toggle button 244 may be located anywhere in the user interface 200. Alternatively or additionally, various row toggle buttons 246 may be included anywhere in the user interface 200 of FIG. 5. Each row toggle button 246 may enable a user to enter a toggling input into the user interface 200 that toggles each of the spanner cells in the corresponding row of the grid 202 between appearing in the first corresponding column spanned by the content of the spanner cell and appearing in the last corresponding column spanned by the content of the spanner cell. It is understood that the toggle buttons 244 and 246 are but one example of a user interface control that could result in a toggling input and any other user interface control or other predetermined input could instead be employed to result in a toggling input.

FIG. 6 discloses the example user interface 200 of FIG. 5 with the spanner cells of one row appearing in the last column of the span. In particular, the state disclosed in FIG. 6 results from the user selecting the row toggle button 246 of the row 248 in FIG. 5, which causes the state of FIG. 6 where each of the spanner cells in the row 248 toggles from appearing in the first corresponding column spanned by the content of the spanner cell to appearing in the last corresponding column spanned by the content of the spanner cell. For example, the spanner cell 234 toggled from appearing in the “2 Months” column in FIG. 5 to appearing in the “5 Months” column in FIG. 6. Similarly, the spanner cell 236 toggled from appearing in the “3 Months” column in FIG. 5 to appearing in the “6 Months” column in FIG. 6. Since the spanner cells 234 and 236 each toggled into a column of the row 248 occupied by at least one other cell, the spanner cells 234 and 236 went from being single cells in FIG. 5 to being part of cluster cells in FIG. 6. Further, the spanner cell 238 toggled from appearing in the “8 Months” column in FIG. 5 to the “13 Months” column in FIG. 6, which causes the spanner cell 238 to move out of the view of the viewport 208 since the viewport 208 only displays columns between “2 Months” and “8 Months” in the position of the viewport 208 disclosed in FIG. 6

As disclosed in FIG. 6, the label on the row toggle button 246 of the row 248 also switched from being “>>|” in FIG. 5, indicating that selecting the button would result in the spanner cells toggling to the last corresponding column, to being “|<<” in FIG. 6, indicating that selecting the button would result in the spanner cells toggling to the first corresponding column. Thus, by pressing the row toggle button 246 of the row 248 in the state of FIG. 6 would result in the spanner cells in the row 248 toggling back to displaying the spanner cells in their first corresponding columns.

FIG. 7 discloses the example user interface 200 of FIG. 5 with all of the multiple spanner cells appearing in the last column of the span. In particular, the state disclosed in FIG. 7 results from the user selecting the grid toggle button 244 in FIG. 5, which causes the state of FIG. 7 where each of the spanner cells in the grid 202 toggles from appearing in the first corresponding column spanned by the content of the spanner cell to appearing in the last corresponding column spanned by the content of the spanner cell. For example, not only did the spanner cells 234, 236, and 238 of the row 248 toggle, as discussed above in connection with FIG. 6, but the spanner cells 240 and 242, as well as all other cells in all other rows of the grid 202, also toggled to appear in the last corresponding column spanned by the content of the spanner cell. In the example embodiment of FIG. 7, it is noted that where a spanner cell includes a range that goes halfway between two columns, the range may be rounded down to the lower column for display purposes. For example, the spanner cell 242 has a range of “(6.5-8.5),” but for display purposes the spanner cell 242 appears in either the “6 Months” column or the “8 Months” column. The range may instead be rounded up, or some combination of rounding down and rounding up.

As disclosed in FIG. 7, the labels on the grid toggle button 244 and the row toggle buttons 246 also switched from being “>>|” in FIG. 5, indicating that selecting the button would result in the corresponding spanner cells toggling to the last corresponding column, to being “|<<” in FIG. 7, indicating that selecting the button would result in the corresponding spanner cells toggling to the first corresponding column. Thus, by pressing any of the grid toggle button 244 and the row toggle buttons 246 in the state of FIG. 7 would result in the corresponding spanner cells toggling back to displaying the spanner cells in their first corresponding columns.

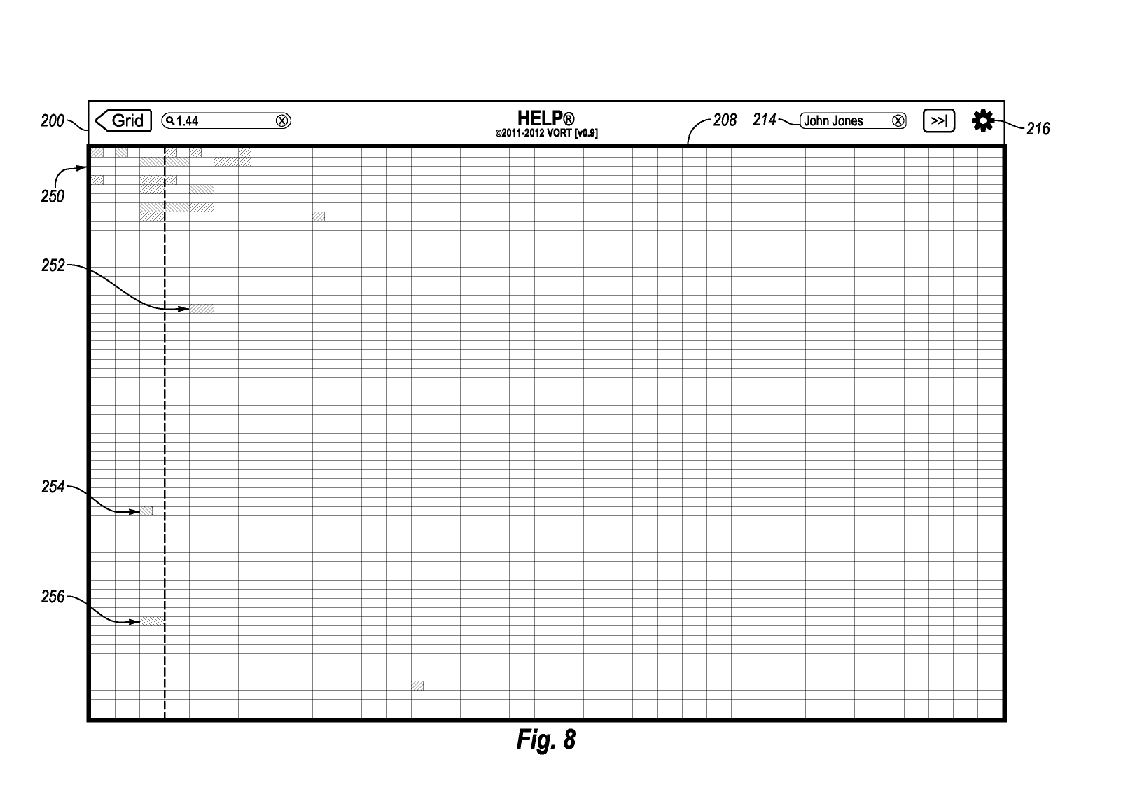

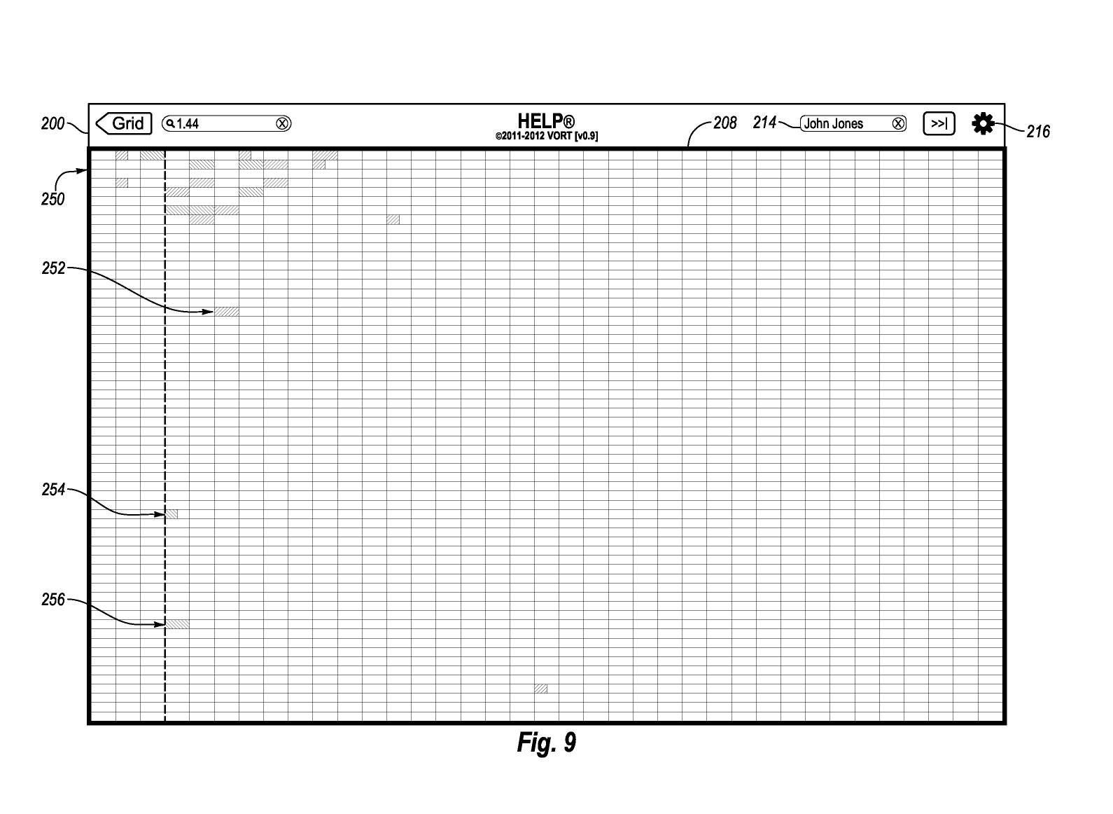

FIG. 8 illustrates the example user interface 200 of FIG. 5 with the viewport 208 displaying a summative grid 250 that corresponds to the grid 202 of FIG. 5 with each summative cell corresponding to a spanner cell appearing in the first column of the span and FIG. 9 illustrates the example user interface 200 of FIG. 8 with each summative cell corresponding to a spanner cell appearing in the last column of the span. The user interface 200 may enable the statuses of the cells in the grid 202 of FIG. 5 to be tracked and then displayed in the summative grid 250 of summative cells. The summative grid 250 may enable a user to view a summary of the statuses of the grid 202, thereby enabling the user to view a gestalt view of the grid statuses. Additional details regarding grid statuses and summative grids are disclosed in U.S. patent application Ser. No. 14/675,317, titled “USER INTERFACES FOR SUMMARIZING STATUSES OF CELLS IN A GRID,” filed on Jan. 11, 2013, and which is incorporated herein by reference in its entirety.

The user interface 200 may be configured to display each summative cell of the summative grid 250 that corresponds to a spanner cell of the grid 202 in either the first corresponding column or row spanned by the content of the spanner cell or the last corresponding column or row spanned by the content of the spanner cell. As disclosed in FIGS. 8 and 9, the grid toggle button 244 causes each summative cell of the summative grid 250 that corresponds to a spanner cell of the grid 202 to toggle from displaying in the first corresponding column spanned by the content of the spanner cell in FIG. 8 to displaying in the last corresponding column spanned by the content of the spanner cell in FIG. 9. For example, summative cells 252 and 256 toggle from being displayed in 5^{th} and 3^{rd} columns in FIG. 8, respectively, to being in 6^{th} and 4^{th} columns in FIG. 9, respectively. Similarly, the summative cell 254, which represents a cluster cell of the grid 202, toggles from being displayed in the 3^{rd} column in FIG. 8 to being displayed in the 4^{th} column in FIG. 9.

Thus, whether the user is viewing the grid 202 through the viewport 208 or the user is viewing the summative grid 250 through the viewport 208, the user interface 200 may be configured to allow a user to toggle between viewing spanner cells (or their corresponding summative cells) in the first corresponding column and view spanner cells (or their corresponding summative cells) in the last corresponding column.

It is understood that although the example toggling of spanner cells herein is disclosed in terms of toggling entire rows or entire grids, more granular toggling of spanner cells is possible. For example, individual columns of spanner cells, portions of columns of spanner cells, portions of rows of spanner cells, custom groups of spanner cells, and even individual spanner cells may be toggled. It is also understood that although the example toggling of spanner cells herein is disclosed in terms of toggling between first and last boundaries of a range, other range positions could instead be employed in toggling such as the 25th percentile of a range, the 50^{th} percentile of a range, the 75^{th} percentile of a range, or any other position within the range, depending on the particular application and particular content of the grid. In embodiments with more than two toggling range positions, a slider control or other type input device or method may be employed instead of a toggle button as a user interface control to result in a toggling input.

It is further understood that although the example user interface 200 is disclosed in FIGS. 1-9 in a tablet computer environment, the user interface 200 may instead be employed in a variety of other environments including other touch display environments as well as non-touch display environments.

The embodiments described herein may include the use of a special purpose or general purpose computer including, but not limited to, a cell phone, smartphone, smart appliance, automobile, navigation system, tablet computer, laptop computer, desktop computer, media player, and the like that is equipped with a display, including various computer hardware or software modules, as discussed in greater detail below.

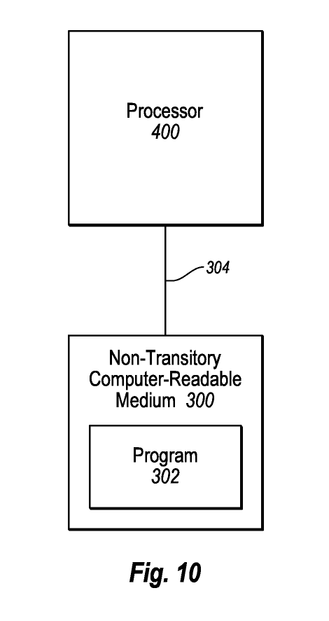

FIG. 10 illustrates an example non-transitory computer-readable medium 300 that may store a program 302 configured to cause a processor 400 to generate any of the example user interfaces of FIGS. 1-9. Embodiments described herein may be implemented using computer-readable media for carrying or having computer-executable instructions or data structures stored thereon, such as the example non-transitory computer-readable medium 300. The computer-readable medium 300 may be any available media that may be accessed (this access is represented by the line 304) by the process 400, which may be included as part of a general purpose or special purpose computer. By way of example, and not limitation, the computer-readable medium 300 may include non-transitory computer-readable storage media including RAM, ROM, EEPROM, CD-ROM or other optical disk storage, magnetic disk storage or other magnetic storage devices, or any other storage medium which may be used to carry or store the program 302, which may include code in the form of computer-executable instructions or data structures and which may be accessed by the processor 400, which may be included as part of a general purpose or special purpose computer. Combinations of the above may also be included within the scope of the computer-readable medium 300.

Computer-executable instructions comprise, for example, instructions and data which cause a general purpose computer, special purpose computer, or special purpose processing device to perform a certain function or group of functions. Although the subject matter has been described in language specific to structural features and/or methodological steps, it is to be understood that the subject matter defined in the appended claims is not necessarily limited to the specific features or steps described above. Rather, the specific features and steps described above are disclosed as example forms of implementing the claims.

As used herein, the term “module” may refer to software objects or routines that execute on a computing system. The different modules described herein may be implemented as objects or processes that execute on a computing system (e.g., as separate threads). While the system and methods described herein are preferably implemented in software, implementations in hardware or a combination of software and hardware are also possible and contemplated.

All examples and conditional language recited herein are intended for pedagogical objects to aid the reader in understanding the example embodiments and the concepts contributed by the inventor to furthering the art, and are to be construed as being without limitation to such specifically-recited examples and conditions.

What is claimed is:

1. A non-transitory computer-readable medium storing a program configured to cause a processor to generate a user interface, the user interface comprising:
a grid including horizontal rows and vertical columns;
a plurality of multidimensional grid cells each having a specific position in the grid; and
a viewport configured to display only a portion of the grid and configured to scroll the grid in any direction within the viewport upon receiving a first diagonal scrolling input that indicates a diagonal scrolling direction, the viewport further configured to scroll the grid exactly along either a column or a row within the viewport upon receiving the first diagonal scrolling input in combination with a simultaneous second input from the user.

2. The non-transitory computer-readable medium as recited in claim 1, wherein the first diagonal scrolling input is a finger swipe on a touch display and the simultaneous second input is a finger touch.

3. The non-transitory computer-readable medium as recited in claim 1, wherein the first diagonal scrolling input is a mouse pointer drag on a display and the simultaneous second input is a keyboard key press.

4. The non-transitory computer-readable medium as recited in claim 1, wherein the first diagonal scrolling input is a mouse pointer drag and a first mouse button press and the simultaneous second input is a second mouse button press.

5. The non-transitory computer-readable medium as recited in claim 1, wherein when the first diagonal scrolling input is received in combination with the simultaneous second input, the viewport is configured to scroll the grid:
exactly along a column within the viewport where a vertical component of the indicated diagonal scrolling direction is more pronounced than a horizontal component of the indicated diagonal scrolling direction; or
exactly along a row within the viewport where the horizontal component of the indicated diagonal scrolling direction is more pronounced than the vertical component of the indicated diagonal scrolling direction.

6. A non-transitory computer-readable medium storing a program configured to cause a processor to generate a user interface, the user interface comprising:
a grid including rows and columns;
a header row of header row cells each positioned in a separate column of the grid; and
a plurality of cells each having a specific position in the grid, the cells including one or more spanner cells, each spanner cell including content that corresponds to multiple header row cells but the spanner cell is displayed in only a single one of the columns in which the corresponding header row cells are positioned.

7. The non-transitory computer-readable medium as recited in claim 6, wherein each spanner cell includes a spanning indicator that indicates the header row cells to which the content of the spanner cell corresponds.

8. The non-transitory computer-readable medium as recited in claim 6, wherein each spanner cell is displayed in either:
the column in which the first corresponding header row cell is positioned; or
the column in which the last corresponding header row cell is positioned.

9. The non-transitory computer-readable medium as recited in claim 8, wherein the user interface is configured to receive one or more toggling inputs that toggle at least some portion of the spanner cells in the grid between being displayed in the column in which the first corresponding header row cell is positioned and being displayed in the column in which the last corresponding header row cell is positioned.

10. The non-transitory computer-readable medium as recited in claim 9, wherein the grid is a summative grid.

11. A non-transitory computer-readable medium storing a program configured to cause a processor to generate a user interface, the user interface comprising:
a grid including rows and columns;
a header column of header column cells each positioned in a separate row of the grid; and
a plurality of cells each having a specific position in the grid, the cells including one or more spanner cells, each spanner cell including content that corresponds to multiple header column cells but the spanner cell is displayed in only a single one of the rows in which the corresponding header column cells are positioned.

12. The non-transitory computer-readable medium as recited in claim 11, wherein each spanner cell includes a spanning indicator that indicates the header column cells to which the content of the spanner cell corresponds.

13. The non-transitory computer-readable medium as recited in claim 11, wherein each spanner cell is displayed in either:
the row in which the first corresponding header column cell is positioned; or
the row in which the last corresponding header column cell is positioned.

14. The non-transitory computer-readable medium as recited in claim 13, wherein the user interface is configured to receive one or more toggling inputs that toggle at least some portion of the spanner cells in the grid between being displayed in the row in which the first corresponding header column cell is positioned and being displayed in the row in which the last corresponding header column cell is positioned.

15. The non-transitory computer-readable medium as recited in claim 14, wherein the grid is a summative grid.
